(19) United States
(12) Patent Application Publication
(10) Pub. No.: US 2008/0034388 A1
(43) Pub. Date: Feb. 7, 2008

(54) System of mobile and stationary digital units using a logical network architecture involving groups and hierarchies

(76) Inventor: Sina Majidi, Thornhill (CA)

Correspondence Address: Sina Majidi, 35 Gretman Cres, Thornhill, ON, L3T5L9, CA

(21) Appl. No.: 11/882,641

(22) Filed: Aug. 3, 2007

Related U.S. Application Data
(60) Provisional application No. 60/821,266, filed on Aug. 3, 2006.

(51) Int. Cl. H04N 5/445

(52) U.S. Cl. 725/37

(57) ABSTRACT

This invention relates to a system consisting of a logical network of units capable of digital communication managed by servers and databases. Such units include LCDs, LEDs, digital billboard, and digital cameras, as well as the technology infrastructure of business entities. The system utilizes user requirements, system configurations, and real-time data to manage transmission of data, including multi-media data such as advertisements. Additionally, the system uses unit groups and hierarchies to select and synchronize communications among units. The relational aspect of units within the logical network also provides a framework for data layering of the communication streams. Existing systems consider units, such as mobile telephones, as stand-alone and provide no relational consideration in controlling data communications. This system targets this deficiency within the marketplace and improves the opportunities that digital units provide. Furthermore, the system serves business-to-business need for more cost-effective management of remote and mobile units.

This invention relates to a system that creates a logical network of communication units (e.g., LCDs, LEDs) that are mobile or stationary, and manages data transmissions and reception using user requirements, system configurations (e.g., groups of LCDs), and real-time data (e.g. location, weather). The system also creates logical hierarchies and groups of both units and other relevant entity types, to select and synchronize communication with units within the network. In a drawing which illustrates embodiments of the invention, FIG. 1 illustrates the use of groups and hierarchies to manage a collection of units by a system. Additionally, the system will use both wired and wireless (e.g., cellular) telecommunications platforms to control and manage its network of units.

Systems that use location-based (spatial) data as criteria for advertising and data transmission to mobile units, such as cellular telephones, already exist in the marketplace. Many patents have been filed that address both the technical and application of these systems, such as CA 2394503. In addition to spatial data, patents have been filed to address other criteria for advertising, such as weather and socio-economic factors, on mobile units. Such patents include U.S. Pat. No. 7,027,801 (Apr. 11, 2006) and CA 2506176 (Nov. 10, 2005).

Existing systems manage these units as stand-alone entities where information is transmitted using business requirements (FIG. 2). However, no patents exist that consider both mobile and stationary transceiver units (send and/or receive data) as a collection of objects that can be managed as a network. Nor, is there any prior art for managing these objects, both units and entities, in groups or hierarchies as part of the network architecture. This patent focuses on these deficiencies within marketplace by outlining a system that manages these units as a relational network (with groups and hierarchies).

Although past patents allow for greater flexibility in defining content for consumers, the inventions are not designed for business-to-business applications. This innovative system allows for greater deployment of digital units (such as LCDs and billboards) by businesses for operational needs and revenue opportunities. Currently, businesses use stand-alone digital and non-digital units because no system exists that manage a scalable system of units. This system will increase the use of digital units by providing a relational network of units that are dynamically managed remotely. In addition, the use of real-time data to control the content of data transmissions will greatly increase the options available to business in managing information.

Specifically for advertisements or digital display data, the system “factors” user requirements and status, along with unit configurations, for real-time dynamic management of data transmission. The factoring performed by the system applies to several variables to ensure that the interests of all stakeholders are satisfied. For example, if a digital display unit is located in a high traffic area versus a low traffic area, the owner of the former unit logically should bill at a higher rate (“higher burn rate”), or as defined in the system a higher factor. This factoring also applies to larger versus smaller display units. Furthermore, if a user has provided a higher budget for an advertisement then it is expected that the advertisement should play at a higher frequency. These features of the system are defined by the below equations:

For example, a system of LCDs and billboards (i.e., units) on buses, trains, and stations (entities), can be managed as a network of objects (FIG. 3). LCDs can be assigned to a specific bus (units grouped under a bus entity) and managed as a collection of units. Groups can then be assigned to super groups (i.e., a hierarchy) in the logical network, such as a bus group or an area group. Thus, when the system broadcasts advertisements to LCDs, the logical network architecture, along with client needs, time, location, events (sports, product promotions, weather, etc.), and date, are used to control what is displayed.

In addition, relational configuration and real-time data, such as a bus or a train approaching a station, that triggers changes in the advertisement selection, are incorporated into the management of the system and control the content of the advertising spaces. FIG. 3 illustrates how such a system can use the hierarchy of groups to logically select LCDs and LED to transmit advertisement data. For example, if users require advertising on all buses, LCD's A through D, will be selected by the system to transmit the multi-media advertisements. Alternatively, if users require broadcast of advertisements in the North-East region, LCD's C, D, and E, along with LED A, will be the targets. The system can also calculate the approach of two buses or a bus to a station to redefine the advertisement selection. As can be seen, such a system is fully scalable to incorporate any number of units and unit types, along with other entities, to manage data transmission.

### DESCRIPTION OF FIGURES

FIG. 1. System groups and hierarchy create a relational network of units that are managed as a collection.

FIG. 2. Existing system configuration where units are considered as stand-alone entities.

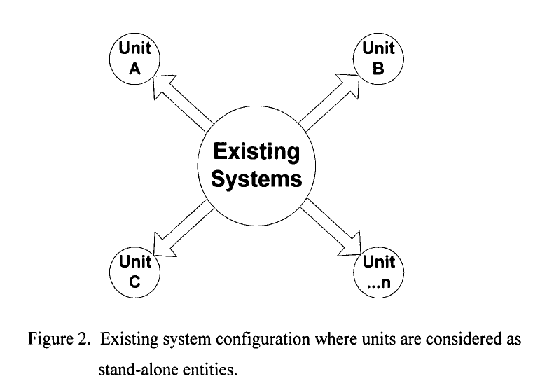

FIG. 3. Example of a system of units and groups, which are used to transmit advertising data to LCDs and LEDs, based buses, billboards, stations, and regional groups.

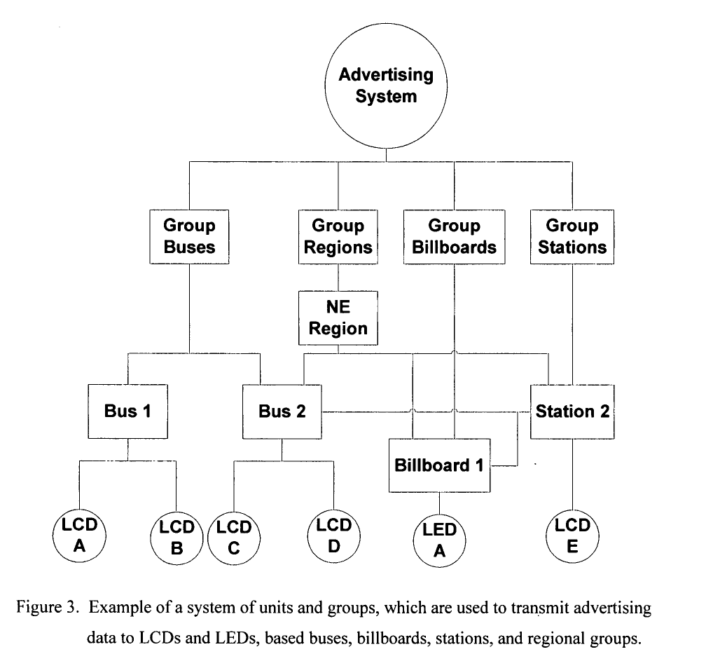

1. The system will transmit and receive data to and from units, such as digital advertising display LCDs, based on various system configurations, user requirements, and real-time data.

2. The system of claim 1 is based on a network configuration of units, with specific unit attributes, to define data transmissions and trigger transmission changes.

3. The system of claim 1, wherein the units will include, but not necessarily restricted to, LCDs, LEDs, servers, digital cameras, digital sensors, and any digital medium.

4. The system configuration of claim 1 will include units assigned to multiple groups as part of its management of the units.

5. The system of claim 4, wherein the groups will include other entity types, other than communication units, as part of its management of units.

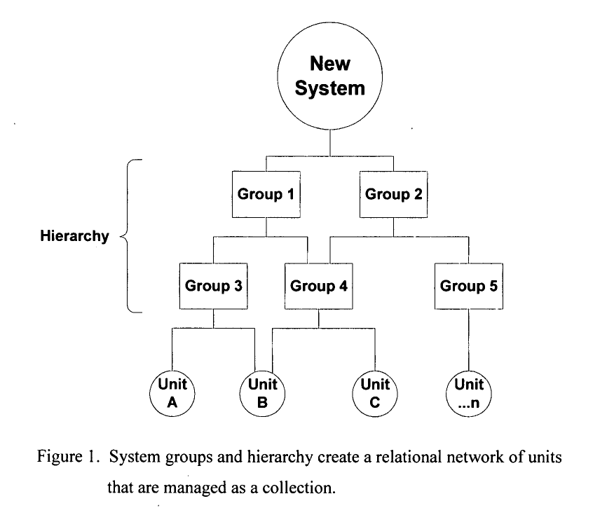

6. The system of claim 4, wherein the systems configuration will have a hierarchal architecture of groups (as shown in FIG. 1) as part of its configuration to manage the network of units.

7. The system of claim 5, wherein the other entity types include, but not necessarily restricted to, areas, vehicles, buildings, and political boundaries.

8. The system of claim 1, wherein the user requirements will be based on, but not necessarily restricted to, information entered into the system such as unit, time, location, events (sports, product promotions, weather, etc.), and date, to control what is broadcast or received.

9. The system of claim 8, wherein the user requirements will include, but not necessarily restricted to, inputted parameters, including group and hierarchy criteria, used by the system's business logic to manage the network of units controlled by the system.

10. The system of claim 1, wherein the user requirements, system configuration, and real-time logic controls, will be entered through, but not necessarily restricted to, a user interface.

11. The system of claim 1, wherein the real-time data will include dynamic relational configurations (e.g., location changes), such as mobile display units approaching stationary units, to trigger changes in the transmission of data, and are used for the management of the network of units.

12. The system of claim 11, wherein the real-time data will include groups and hierarchies in its management of units and synchronization of data among groups and units.

13. The system of claim 11, wherein the real-time data management, will include synchronization of data channels within units, such as matching content among the different split-screens of a digital display and the inclusion of a extra data stream to transmit data directly to consumer units (e.g. retail coupons and location information).

14. The system of claim 11, wherein the real-time data management, will include data layering (e.g., a data stream, such as an advertisement, will consist of multiple layers of data where one or more layers will include particular data, such as retail store location, specific to a group or unit).

15. The system of claim 2 will use attributes of units, such as type, location, grouping, and hierarchy assignments, to manage the network of units and control data transmissions.

16. The system of claim 1 consists of servers and databases that manage the transmission of data.

17. The system of claim 1 will use both wireless and wired networks, such as LAN, WAN, TCP/IP, ATM/FR, WiFi, and Cellular.

18. The system of claim 1 can utilize any communications protocol including both proprietary and non-proprietary.
